(19) United States
(12) Patent Application Publication
(10) Pub. No.: US 2005/0200444 A1
(43) Pub. Date: Sep. 15, 2005

(54) Silver contact connection structure for conductive blades

(76) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(21) Appl. No.: 10/798,384

(22) Filed: Mar. 12, 2004

(51) Int. Cl. H01H 85/02

(52) U.S. Cl. 337/198

(57) ABSTRACT

A silver contact connection structure for conductive blades aims at providing a technique for fabricating a thin silver contact. The technique includes forming an extended fastening section from the surface of a conductive blade by machining; wedging the conductive blade in an upper mold that has a retaining surface mating the fastening section; placing a silver wire into the fastening section; and stamping the silver wire through a lower mold. The retaining wall holds the fastening section to prevent the fastening section from fracturing when the thin conductive blade is subject to the impact of stamping.

### FIELD OF THE INVENTION

The present invention relates to a silver contact connection structure for conductive blades and particularly to a technique that employs a novel conductive blade structure to fabricate a thin silver contact.

### BACKGROUND OF THE INVENTION

Referring to FIG. 1, a conventional silver contact is usually formed on a conductive blade at a desired location by pressing and filling a silver wire by stamping. The thin silver contact fabricated by such a design has to withstand a striking force to complete the connection of the contact when in use. As the contact friction area between the conductive blade and the thin silver contact is small, the silver contact is prone to breaking loose and shortening its service life.

There is another technique for fabricating silver contacts disclosed in R.O.C. patent publication No. 448454 entitled “Method for fastening silver contacts of conductive blades”. It punches a fastening hole on a conductive blade that is concave on the upper side and convex on the lower side. Extra material for the conductive blade is extruded to form an extended wedging flange. The fastening hole has screw threads formed therein to provide a horizontal frictional force so that the silver contact is less likely to break off. Finally, the top section of the conductive metal forms a bucking flange through an upper mold, and a lower mold is deployed to ram the wedging flange towards the fastening hole so that the conductive metal is filled and wedged securely in the fastening hole.

The aforesaid technique can fix the silver contact more securely without breaking loose. However, when designing switches, in order to flexibly achieve a safe interval (for instance, the interval is 3 mm in European safety regulations), a thinner silver contact is needed. The conventional technique mentioned above has a bucking flange on the outer side of the silver contact that increases the thickness of the silver contact. It cannot meet the requirements of fabricating the thin silver contact as desired.

### SUMMARY OF THE INVENTION

The primary object of the invention is to solve the aforesaid problems. The invention provides a conductive blade structure with a thin silver contact. In one aspect, the conductive blade has a fastening section extended from the surface of the conductive blade. The fastening section is wedged in an upper mold that has a retaining surface mating the shape of the fastening section. When the silver contact is thin and the conductive blade is subject to a stamping force, the fastening section does not fracture.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross section of a conventional silver contact.

FIG. 2 is a perspective view of a first embodiment of the conductive blade of the present invention

FIGS. 3A and 3B are schematic views of the fabrication process of the first embodiment of the invention.

FIGS. 4A and 4B are schematic views of the fabrication process of a second embodiment of the invention.

FIG. 5 is a cross section of a third embodiment of the invention.

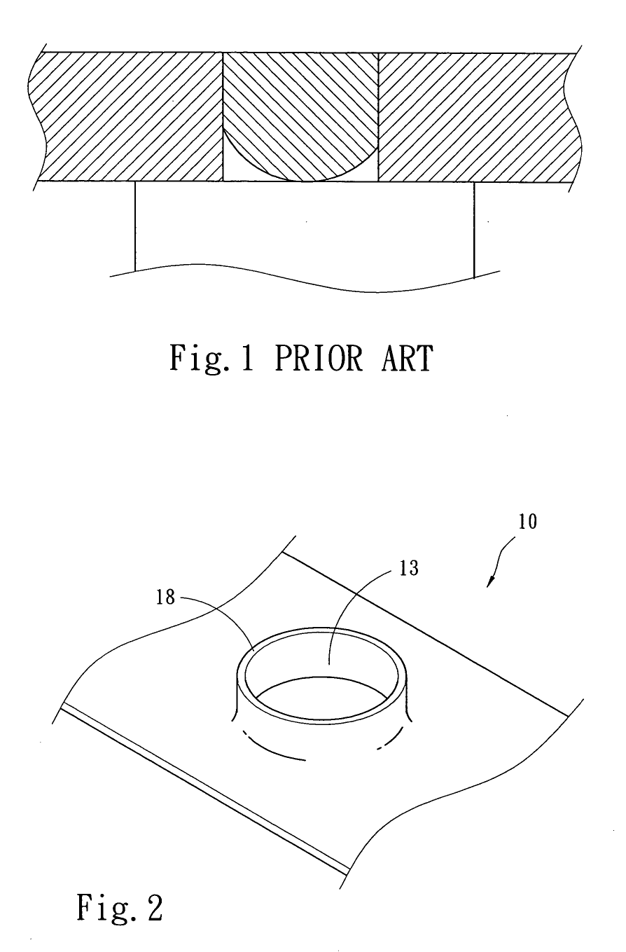

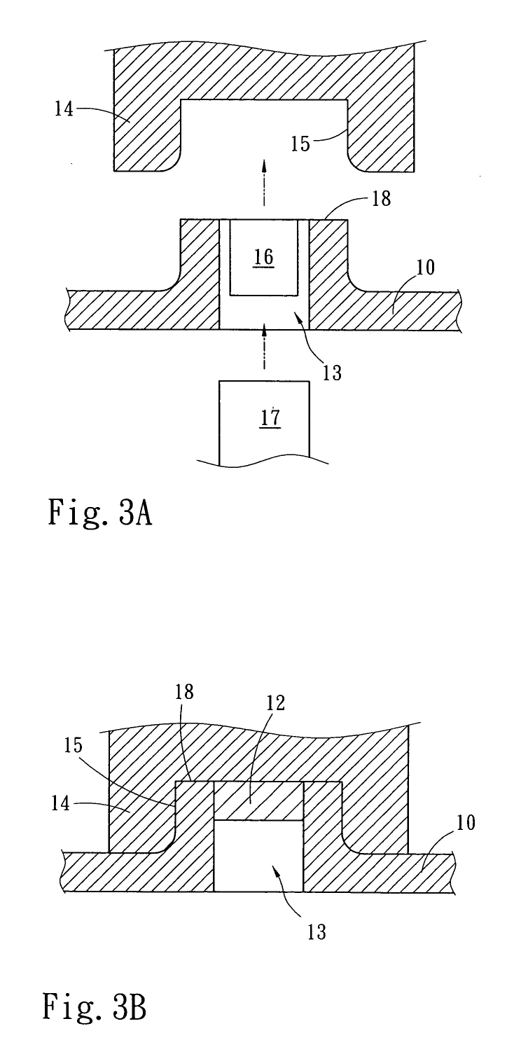

### DETAILED DESCRIPTION OF THE PREFERRED EMBODIMENTS

Please refer to FIGS. 2,3-A and 3-B for a thin conductive blade 10 of a first embodiment of the invention. It has a fastening section 13 extended from the surface of the conductive blade 10 for mounting a silver contact 12. The fastening section 13 formed in a through hole on both sides. The fastening section 13 has one end directed towards another end radially. The fabrication process is as follow: A: fabricating the fastening section, and B: planting a silver wire.

Step A is to form the fastening section 13 extended from the surface of the conductive blade 10 by machining (not shown in the drawings, in the embodiment of the invention) at a location where the silver contact 12 is to be mounted. The fastening section 13 has one end directed towards another end radially to form a hole through both sides.

Step B is to plant a silver wire. First wedge the conductive blade 10 in an upper mold 14 which has a retaining surface 15 mating the shape of the fastening section 13; dispose a silver wire 16 on the fastening section 13; press and fill the silver wire 16 into the fastening section 13 through a lower mold 17; hold the fastening section 13 through the retaining surface 15 to prevent the fastening section 13 from fracturing when subject to a stamping force.

In addition, another surface of the conductive blade 10 corresponding to the fastening section 13 forms a striking zone 18 through machining (not shown in the drawings). The striking surface 18 serves to establish conduction for the silver contact 12 after the silver contact 12 is formed.

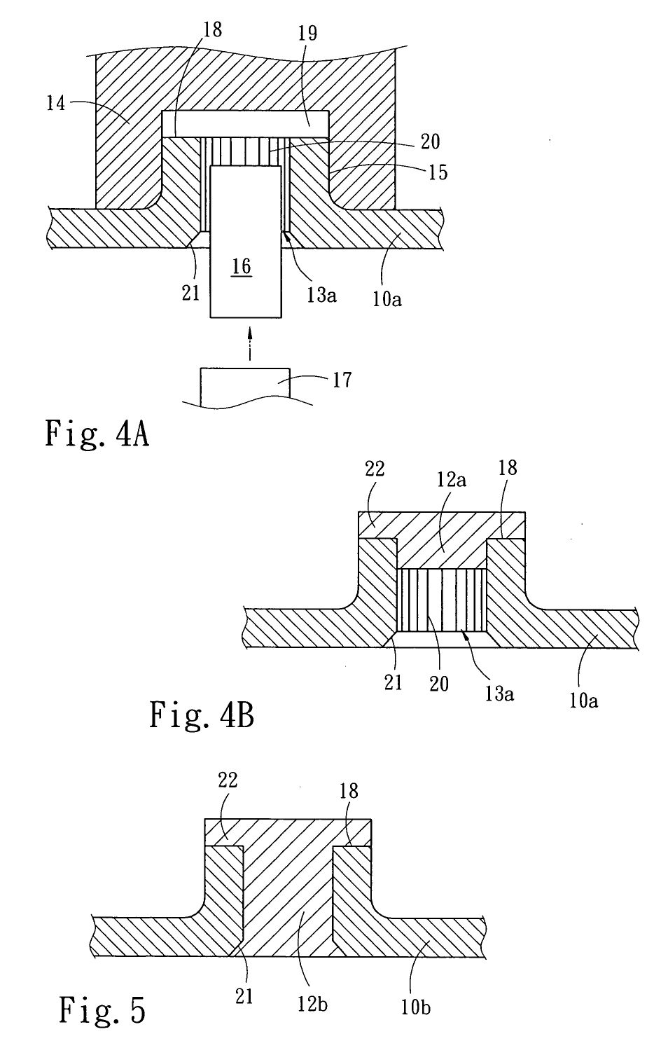

Refer to FIGS. 4A and 4B for a second embodiment of the invention. Its fabrication process is substantially the same as the one previously discussed. The difference is at step B for planting the silver wire. When the conductive blade 10a is placed on the upper mold 14, a housing space 19 is spared between the fastening section 13a and the upper mold 14. The silver wire 16 is placed in the fastening section 13a, and is pressed and filled in the fastening section 13a through the lower mold 17. In this embodiment, the finished silver contact 12a forms a bucking flange 22 on the periphery of one end of the fastening section 13a.

In addition, in this embodiment the molds being used have non-circular horizontal cross sections to form a fixing zone 20 in the fastening section 13a. The fixing zone 20 also has a non-circular horizontal cross section matching the molds. In this embodiment, the horizontal cross section of the fixing zone 20 is formed in a saw shape.

Refer to FIG. 5 for a third embodiment of the conductive blade 10b. It adopts a fabrication process similar to the one previously discussed. But at step B for planting the silver wire, the amount of the silver wire 16 used is increased (also referring to FIG. 4A), and the silver contact 12b is pressed and filled into the fastening section 13b through the lower mold 17. In addition, the fastening section 13a has a bucking end 21 that is also filled. The bucking end 21 is formed with a chamfered angle to provide a bucking force and prevent the silver contact 12b from breaking loose when subject to a striking force to establish conduction.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments that do not depart from the spirit and scope of the invention.

1. A silver contact connection structure for conductive blades comprising a conductive blade and a fastening section extended from the surface of the conductive blades for holding a silver contact, the fastening section being a hole through both sides.

2. The silver contact connection structure of claim 1, wherein the fastening section is non-circular along any horizontal cross section.

3. The silver contact connection structure of claim 1, wherein the silver contact connection structure is formed by a fabrication method which comprises steps of:
A. fabricating the extended fastening section on the conductive blade by machining for holding the silver contact; and
B. planting a silver wire by wedging the conductive blade in an upper mold which has a retaining surface mating the shape of the fastening section, and placing the silver wire into the fastening section, and pressing and filling the silver wire in the fastening section through a lower mold.

4. The silver contact connection structure of claim 3, wherein the step B for planting a silver wire is preceded by forming a striking zone on another surface of the conductive blade by machining that corresponds to the fastening section.

5. The silver contact connection structure of claim 1, wherein the silver contact connection structure is formed by a fabrication method which comprises steps of:
A. fabricating the extended fastening section on the conductive blade by machining for holding the silver contact; and
B. planting a silver wire by wedging the conductive blade in an upper mold which has a retaining surface mating the shape of the fastening section, forming a housing space between the fastening section and the upper mold, placing the silver wire into the fastening section, and pressing and filling the silver wire in the fastening section.

6. The silver contact connection structure of claim 5, wherein the fastening section has a bucking end on one end thereof formed in a chamfered angle.
